(19) United States
(12) Patent Application Publication
(10) Pub. No.: US 2014/0113465 A1
(43) Pub. Date: Apr. 24, 2014

(54) ELECTRICAL CONNECTOR AND ELECTRICAL CONNECTOR COMBINATION

(71) Applicant: Huawei Technologies Co., Ltd., Shenzhen (CN)

(72) Inventors: Zhigang Zhao, Shenzhen (CN); Congtu Xiao, Shenzhen (CN); Weichun Du, Shenzhen (CN); Jiatie Lin, Shenzhen (CN)

(73) Assignee: Huawei Technologies Co., Ltd., Shenzhen (CN)

(21) Appl. No.: 14/143,419

(22) Filed: Dec. 30, 2013

Related U.S. Application Data
(63) Continuation of application No. PCT/CN2012/072937, filed on Mar. 23, 2012.

(30) Foreign Application Priority Data
Jul. 15, 2011 (CN) 201110199119.2

(51) Int. Cl. H01R 13/46

(52) U.S. Cl. CPC H01R 13/46
USPC 439/78; 439/660

(57) ABSTRACT

An electrical connector includes a plastic body, a first terminal and a second terminal. The first terminal includes a first connecting part, a first contact part and a first mating part extending from two ends of the first connecting part. The first contact part and the first mating part are located at two sides of the first connecting part respectively. An extending direction of the first contact part deviates from a straight line of an extending direction of the first mating part. The first terminal and the second terminal pass through through holes of the plastic body respectively. The first contact part and the first mating part of the first terminal respectively protrude out of the through hole that the first terminal passes through; a second contact part and a second mating part of the second terminal respectively protrude out of the through hole that the second terminal passes through.

### CROSS-REFERENCE TO RELATED APPLICATIONS

This application is a continuation of International Application No. PCT/CN2012/072937, filed on Mar. 23, 2012, which claims priority to Chinese Patent Application No. 201110199119.2, filed on Jul. 15, 2011, both of which are hereby incorporated by reference in their entireties.

### TECHNICAL FIELD

The present application relates to the field of electronic technologies, and in particular, to an electrical connector and an electrical connector combination.

### BACKGROUND

A high safety requirement is imposed on an existing power supply electrical connector during use in a harsh environment because of the harsh environment. However, the existing power supply electrical connector likely fails to meet the safety requirement, causing an accident such as burnout of a circuit board.

### SUMMARY

To meet a high safety requirement, the present application provides an electrical connector, an electrical connector combination, and a circuit board combination.

An electrical connector provided by the present application includes: a plastic body, a first terminal, and a second terminal, where the first terminal includes a first connecting part, and a first contact part and a first mating part that extend from two ends of the first connecting part respectively, the first contact part and the first mating part are located at two sides of the first connecting part respectively, and an extending direction of the first contact part deviates from a straight line of an extending direction of the first mating part; the second terminal includes a second connecting part, and a second contact part and a second mating part that extend from two ends of the second connecting part respectively; the plastic body is opened with a plurality of through holes, the first terminal and the second terminal pass through the through holes of the plastic body respectively, the first contact part and the first mating part of the first terminal respectively protrude out of the through hole that the first terminal passes through, and the second contact part and the second mating part of the second terminal respectively protrude out of the through hole that the second terminal passes through; and a spacing between the first mating part and the second mating part is greater than a spacing between the first contact part and the second contact part.

An electrical connector combination provided by the present application includes a first electrical connector and a second electrical connector, where
the first electrical connector includes: a first plastic body, a first terminal, a second terminal, and side walls; the first terminal includes a first connecting part, and a first contact part and a first mating part that extend from two ends of the first connecting part respectively, the first contact part and the first mating part are located at two sides of the first connecting part respectively, and an extending direction of the first contact part deviates from a straight line of an extending direction of the first mating part; the second terminal includes a second connecting part, and a second contact part and a second mating part that extend from two ends of the second connecting part respectively; the first plastic body is opened with a plurality of first through holes, the first terminal and the second terminal pass through the first through holes of the first plastic body respectively, the first contact part and the first mating part of the first terminal respectively protrude out of the first through hole that the first terminal passes through, and the second contact part and the second mating part of the second terminal respectively protrude out of the first through hole that the second terminal passes through; a spacing between the first mating part and the second mating part is greater than a spacing between the first contact part and the second contact part; the side walls are located at two ends of the first plastic body, and extend in a direction substantially parallel to the first contact part or the second contact part;
the second electrical connector includes a second plastic body which is in an elongated shape and is opened with second through holes, conductive terminals disposed in the second through holes of the second plastic body, and a guide structure protruding from one end of the second plastic body in a longitudinal direction, the guide structure extends across an entire width direction of the second plastic body, a first end of one of the second through holes is located on an end surface of the end of the second plastic body from which the guide structure protrudes, and one of the conductive terminals protrudes out of the second through hole from a second end of the second through hole; and
one end of the second electrical connector from which the guide structure protrudes is inserted between the two side walls of the first electrical connector, and the first contact part and the second contact part of the first electrical connector are inserted into the second through holes from first ends of the second through holes, so as to be electrically connected to the conductive terminals of the second electrical connector.

A circuit board combination provided by the present application includes a first circuit board, a second circuit board, a first electrical connector, and a second electrical connector, where
the first electrical connector includes: a first plastic body, a first terminal, a second terminal, and side walls; the first terminal includes a first connecting part, and a first contact part and a first mating part that extend from two ends of the first connecting part respectively, the first contact part and the first mating part are located at two sides of the first connecting part respectively, and an extending direction of the first contact part deviates from a straight line of an extending direction of the first mating part; the second terminal includes a second connecting part, and a second contact part and a second mating part that extend from two ends of the second connecting part respectively; the first plastic body is opened with a plurality of first through holes, the first terminal and the second terminal pass through the first through holes of the first plastic body respectively, the first contact part and the first mating part of the first terminal respectively protrude out of the first through hole that the first terminal passes through, and the second contact part and the second mating part of the second terminal respectively protrude out of the first through hole that the second terminal passes through; a spacing between the first mating part and the second mating part is greater than a spacing between the first contact part and the second contact part; the side walls are located at two ends of the first plastic body, and extend in a direction substantially parallel to the first contact part or the second contact part;
the second electrical connector includes a second plastic body which is in an elongated shape and is opened with second through holes, conductive terminals disposed in the second through holes of the second plastic body, and a guide structure protruding from one end of the second plastic body in a longitudinal direction, the guide structure extends across an entire width direction of the second plastic body, a first end of one of the second through holes is located on an end surface of the end of the second plastic body from which the guide structure protrudes, and one of the conductive terminals protrudes out of the second through hole from a second end of the second through hole;
one end of the second electrical connector from which the guide structure protrudes is inserted between the two side walls of the first electrical connector, and the first contact part and the second contact part of the first electrical connector are inserted into the second through holes from first ends of the second through holes, so as to be electrically connected to the conductive terminals of the second electrical connector; and
the first mating part and the second mating part of the first electrical connector in the electrical connector combination are inserted into or soldered to the first circuit board respectively, so as to be electrically connected to the first circuit board; and one end which is of the conductive terminals of the second electrical connector in the electrical connector combination and protrudes out of the second through holes is inserted into or soldered to the second circuit board, so as to be electrically connected to the second circuit board.

In embodiments of the present application, because the first contact part and the second contact part are disposed at a small spacing and a high density, high density mating with terminals of another electrical connector can be implemented, and because the first mating part and the second mating part are disposed at a large spacing and a low density, a large creepage distance is provided, which may meet a high safety requirement, so that a device is not likely to be damaged due to failure to meet the high safety requirement.

### BRIEF DESCRIPTION OF DRAWINGS

To describe the technical solutions in the embodiments of the present application more clearly, the following briefly introduces accompanying drawings required for describing the embodiments. Apparently, the accompanying drawings in the following description merely show some embodiments of the present application, and persons of ordinary skill in the art may further obtain other drawings according to these accompanying drawings without creative efforts.

FIG. 1 is a schematic diagram of an embodiment of an electrical connector according to the present application;

FIG. 2 is a schematic diagram of a first terminal in an embodiment of an electrical connector according to the present application;

FIG. 3 is a schematic diagram of a plastic body in an embodiment of an electrical connector according to the present application;

FIG. 4 is a schematic diagram of a second terminal in an embodiment of an electrical connector according to the present application;

FIG. 5 is a schematic diagram of another second terminal in an embodiment of an electrical connector according to the present application;

FIG. 6 is a schematic diagram of a third terminal in an embodiment of an electrical connector according to the present application;

FIG. 7 is a sectional view of an embodiment of an electrical connector according to the present application;

FIG. 8 is a schematic diagram of an embodiment of a circuit board combination according to the present application; and

FIG. 9 is a schematic diagram of an embodiment of a second electrical connector according to the present application.

### DESCRIPTION OF EMBODIMENTS

The following clearly describes the technical solutions in the embodiments of the present application with reference to the accompanying drawings in the embodiments of the present application. Apparently, the embodiments to be described are merely apart rather than all of the embodiments of the present application. All other embodiments obtained by persons of ordinary skill in the art based on the embodiments of the present application without creative efforts shall fall within the protection scope of the present application.

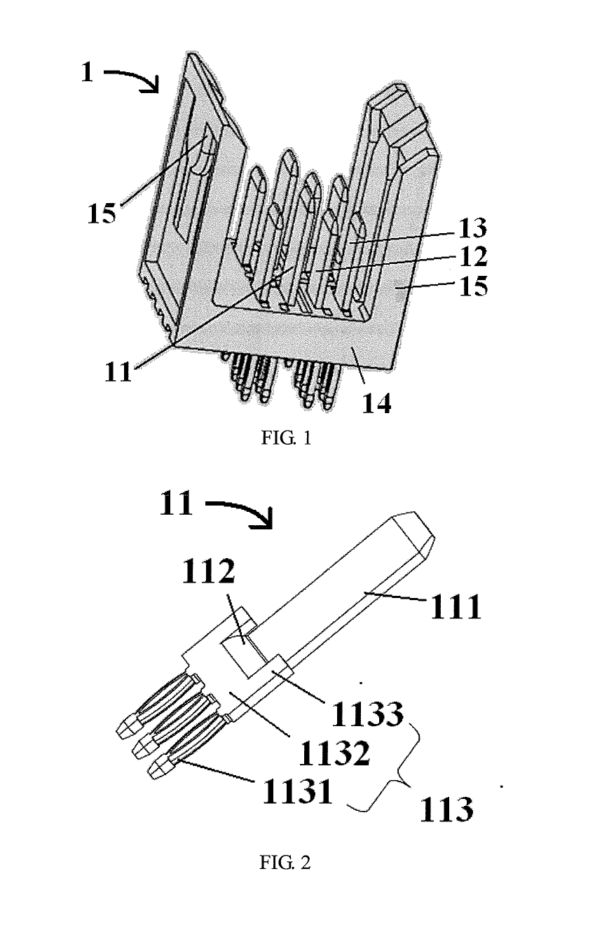

As shown in FIG. 1 to FIG. 5, an embodiment of an electrical connector 1 according to the present application includes a plastic body 14, a first terminal 11, and a second terminal 12. The first terminal 11 includes a first connecting part 112, and a first contact part 111 and a first mating part 113 that extend from two ends of the first connecting part respectively. The first contact part 111 and the first mating part 113 are located at two sides of the first connecting part 112 respectively, and an extending direction of the first contact part 111 deviates from a straight line of an extending direction of the first mating part 113. The second terminal 12 includes a second connecting part 122, and a second contact part 121 and a second mating part 123 that extend from two ends of the second connecting part 122 respectively. The plastic body 14 is opened with a plurality of through holes 141. The first terminal 11 and the second terminal 12 pass through the through holes 141 of the plastic body 14 respectively. The first contact part 111 and the first mating part 113 of the first terminal 11 respectively protrude out of the through hole 141 that the first terminal 11 passes through. The second contact part 121 and the second mating part 123 of the second terminal 12 respectively protrude out of the through hole 141 that the second terminal 12 passes through. A spacing between the first mating part 113 and the second mating part 123 is greater than a spacing between the first contact part 111 and the second contact part 121.

When being used, the electrical connector may be mounted on a device A (for example, a circuit board or a cable), and mated with another electrical connector mounted on a device B (for example, a circuit board or a cable), so as to implement an electrical connection between the device A and the device B.

When the electrical connector provided by the present application is mounted on the device A, the first mating part of the first terminal and the second mating part of the second terminal are inserted into the device A, and the first contact part of the first terminal and the second contact part of the second terminal are in contact with terminals of another electrical connector, so as to implement an electrical connection.

In the electrical connector provided in the embodiment of the present application, because the first contact part and the second contact part are disposed at a small spacing and a high density, high density mating with terminals of another electrical connector can be implemented, and because the first mating part and the second mating part are disposed at a large spacing and a low density, a large creepage distance is provided, which may meet a high safety requirement, so that a device is not likely to be damaged due to failure to meet the high safety requirement. For example, in the electrical connector provided in the embodiment of the present application, on a precondition that the spacing between the first contact part and the second contact part is smaller than 2 mm, the spacing between the first mating part and the second mating part is greater than or equal to 2 mm, and a creepage distance between the first mating part and the second mating part is also greater than or equal to 2 mm.

In a case that the device A is a circuit board, the circuit board is disposed with mounting holes or soldering pads, and the first mating part and the second mating part are inserted into the mounting holes or soldered to the soldering pads, so as to implement an electrical connection with the circuit board. Because the spacing between the first mating part and the second mating part is greater than or equal to 2 mm, a spacing between the mounting holes or the soldering pads on the circuit board is also greater than or equal to 2 mm, which may meet a high safety requirement, so that burnout of the circuit board is not likely to occur.

Furthermore, in the electrical connector provided in the embodiment of the present application, the spacing between the first contact part and the second contact part may be set according to a density of terminals in another electrical connector, so as to implement mating with the another electrical connector. Moreover, because the spacing between the first mating part and the second mating part of the electrical connector provided in the embodiment of the present application is large, a long safety distance may still be implemented. Therefore, it is implemented that the electrical connector provided in the embodiment of the present application is compatible with a high-intensity electrical connector.

As shown in FIG. 2, in the electrical connector provided in the embodiment of the present application, the first contact part 111 and the first mating part 113 of the first terminal 11 may extend from upper and lower ends of the first connecting part 112 respectively. In addition, the first contact part 111 and the first mating part 113 are located at left and right sides of the first connecting part 112, respectively, and the extending direction of the first contact part 111 deviates from the straight line of the extending direction of the first mating part 113. Specifically, a straight line of the extending direction of the first contact part 111 is substantially parallel to the straight line of the extending direction of the first mating part 113. For example, the first terminal 11 is substantially “Z”-shaped.

In the electrical connector provided in the embodiment of the present application, the second terminal may be disposed in the following two manners:

As shown in FIG. 4, in a first manner, the second contact part 121 and the second mating part 123 are located at two sides of the second connecting part 122 respectively, and an extending direction of the second contact part 121 deviates from a straight line of an extending direction of the second mating part 123. Specifically, a straight line of the extending direction of the second contact part 121 is substantially parallel to the straight line of the extending direction of the second mating part 123. For example, the second terminal 12 is substantially “Z”-shaped.

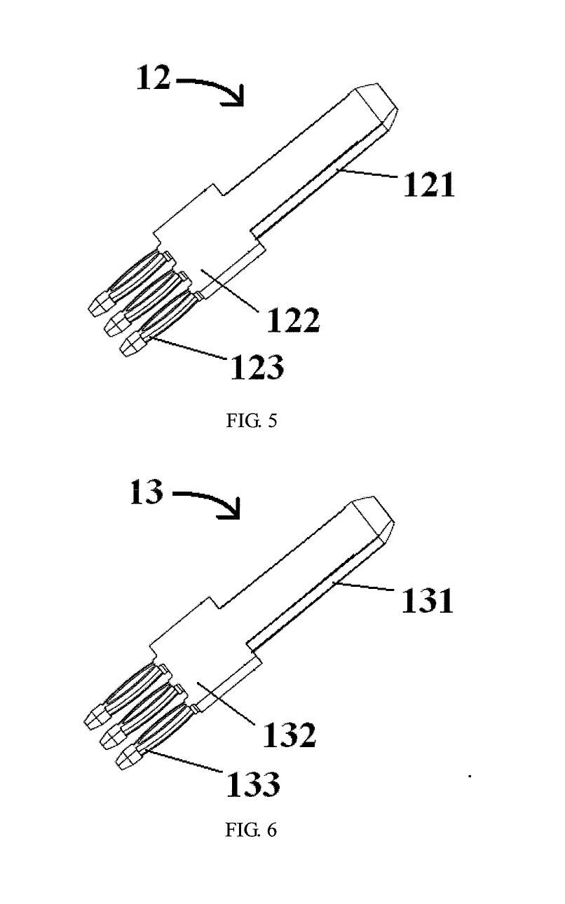

As shown in FIG. 5, in a second manner, a straight line of an extending direction of the second contact part 121 substantially coincides with a straight line of an extending direction of the second mating part 123. For example, the second terminal 12 is substantially “1”-shaped.

As shown in FIG. 1, the number of the first terminals 11 may be one or more, and the one or more first terminals 11 are arranged in a row; and the number of the second terminals 12 may also be one or more, and the one or more second terminals 12 are arranged in a row. The row of first terminals 11 and the row of second terminals 12 may be two parallel rows.

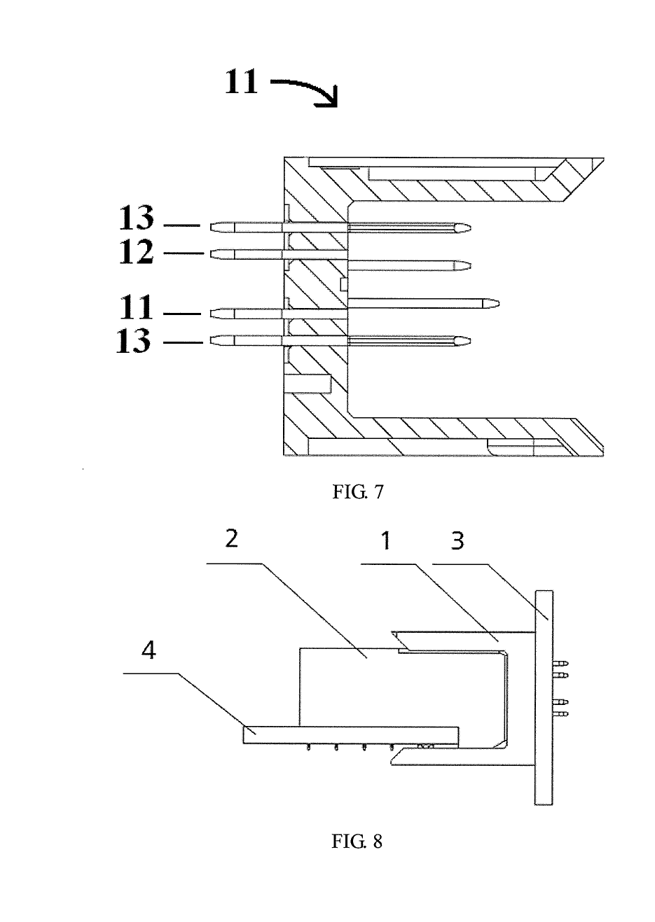

As shown in FIG. 7, when the second terminal 12 is disposed in the first manner, the first terminal 11 may be disposed opposite to the second terminal 12, so that the spacing between the first mating part 113 and the second mating part 123 is greater than the spacing between the first contact part 111 and the second contact part 121.

In addition, when the second terminal is disposed in the second manner, the first terminal is disposed facing the second terminal, so that the spacing between the first mating part and the second mating part is greater than the spacing between the first contact part and the second contact part.

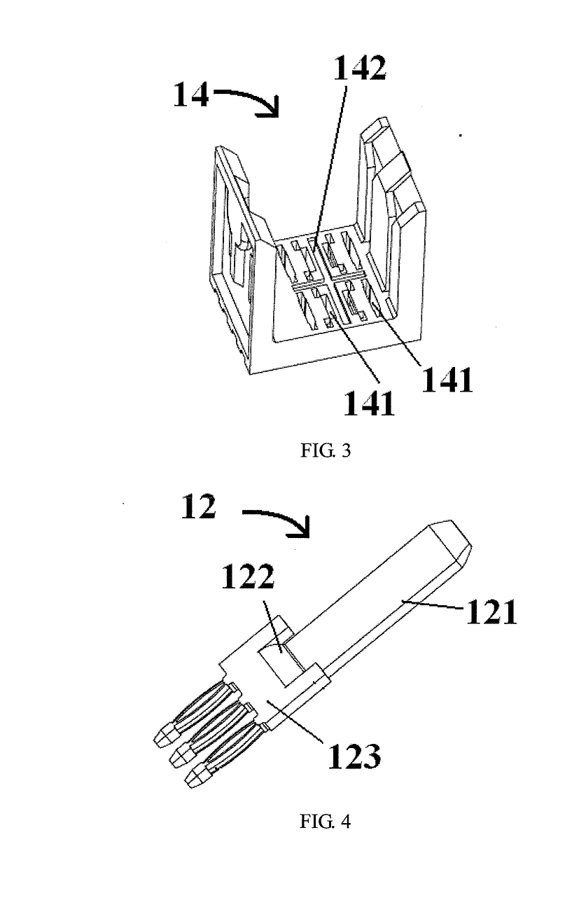

Furthermore, as shown in FIG. 3, to meet a higher safety requirement, the plastic body 14 is opened with a continuous or intermittent groove 142 or provided with a continuous or intermittent protruding rib (not shown in the figure) on a surface facing the first contact part and the second contact part, and the groove 142 or the protruding rib is located between the first contact part and the second contact part, which may increase a surface insulation distance between the first terminal and the second terminal, so as to further increase a creepage distance between the first terminal and the second terminal.

As shown in FIG. 6, in the electrical connector provided in the embodiment of the present application, a third terminal 13 may be further disposed. The third terminal 13 includes a third connecting part 132, a third contact part 131 and a third mating part 133 that extend from two ends of the third connecting part 132 respectively. An extending direction of the third contact part 131 substantially coincides with a straight line of an extending direction of the third mating part 133. The third terminal 13 passes through a through hole of the plastic body, and the third contact part 131 and the third mating part 133 protrude out of the through hole respectively. Specifically, the third terminal 13 maybe substantially “1”-shaped.

As shown in FIG. 1, the number of the third terminals 13 may be one or more. The one or more third terminals 13 may be arranged in a row, and the row of third terminals 13 may be located adjacent to one side of the row of first terminals 11; or the row of third terminals 13 is located adjacent to one side of the row of second terminals 12. Alternatively, the third terminals 13 are arranged in two rows, one row of third terminals 13 is located adjacent to one side of the row of first terminals 11, and the other row of third terminals 13 is located adjacent to one side of the row of second terminals 12.

As shown in FIG. 2, in the electrical connector provided in the embodiment of the present application, the first mating part 113 of the first terminal 11 includes at least one pin 1131 and a holding part 1132. The pin 1131 and the first connecting part 112 are connected to two opposite ends of the holding part 1132 respectively. The holding part 1132 is used for fixing the first terminal 11 to the through hole of the plastic body.

As shown in FIG. 2, in the electrical connector provided in the embodiment of the present application, the first mating part 113 may further include poles 1133. Each pole 1133 protrudes from an end surface of one end of the holding part 1132, and the end surface is an end surface of the end connected to the first connecting part 112.

When the first terminal is inserted into the through hole of the plastic body from bottom to top, the holding part and the first contact part abut against two opposite side walls of the through hole respectively, so as to better maintain balance of the first terminal.

When the first terminal is electrically connected to a circuit board, the circuit board is provided with a mounting hole. When the first terminal is pressed into the mounting hole of the circuit board, a force may be applied to the pole, so that the first terminal receives the force at a position that is in the same straight line as the first mating part, making deformation or displacement of the first terminal not likely to occur.

As shown in FIG. 1, the electrical connector 1 provided in the embodiment of the present application may further include side walls 15 which are at two ends of the plastic body 14 and extend in a direction substantially parallel to the first contact part or the second contact part.

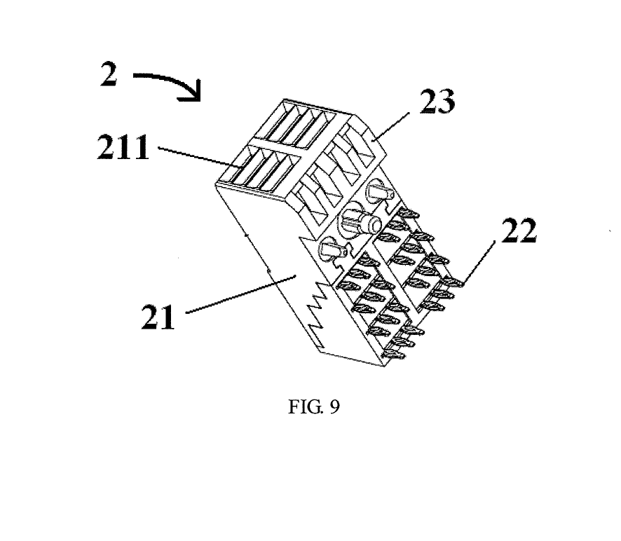

As shown in FIG. 1 to FIG. 5, and FIG. 8 to FIG. 9, the present application further provides an electrical connector combination, including a first electrical connector 1 and a second electrical connector 2. The first electrical connector 1 includes a first plastic body 14, a first terminal 11, a second terminal 12, and side walls 15. The first terminal 11 includes a first connecting part 112, and a first contact part 111 and a first mating part 113 that extend from two ends of the first connecting part respectively. The first contact part 111 and the first mating part 113 are located at two sides of the first connecting part 112 respectively. An extending direction of the first contact part 111 deviates from a straight line of an extending direction of the first mating part 113. The second terminal 12 includes a second connecting part 122, and a second contact part 121 and a second mating part 123 that extend from two ends of the second connecting part 122 respectively. The first plastic body 14 is opened with a plurality of first through holes 141. The first terminal 11 and the second terminal 12 pass through the first through holes 141 of the first plastic body 14 respectively. The first contact part 111 and the first mating part 113 of the first terminal 11 respectively protrude out of the first through hole 141 that the first terminal 11 passes through. The second contact part 121 and the second mating part 123 of the second terminal 12 respectively protrude out of the first through hole 141 that the second terminal 12 passes through. A spacing between the first mating part 113 and the second mating part 123 is greater than a spacing between the first contact part 111 and the second contact part 121. The side walls 15 are located at two ends of the first plastic body 14, and extend in a direction substantially parallel to the first contact part or the second contact part.

The second electrical connector 2 includes a second plastic body 21 which is in an elongated shape and is opened with second through holes 211, conductive terminals 22 disposed in the second through holes 211 of the second plastic body 21, and a guide structure 23 protruding from one end of the second plastic body in a longitudinal direction. The guide structure 23 extends across an entire width direction of the second plastic body 21. A first end of one of the second through holes 211 is located on an end surface of the end of the second plastic body 21 from which the guide structure 23 protrudes. One of the conductive terminals 22 protrudes out of the second through hole 211 from a second end of the second through hole 211.

One end of the second electrical connector 2 from which the guide structure 23 protrudes is inserted between the two side walls 15 of the first electrical connector 1, and the first contact part 111 and the second contact part 121 of the first electrical connector 1 are inserted into the second through holes 211 from first ends of the second through holes 211, so as to be electrically connected to the conductive terminals 22 of the second electrical connector 2.

In the electrical connector combination provided in the embodiment of the present application combination, because the first contact part and the second contact part are disposed at a small spacing and a high density, high density mating with the conductive terminals of the second electrical connector can be implemented, and because the first mating part and the second mating part are disposed at a large spacing and a low density, a large creepage distance is provided, which may meet a high safety requirement, so that a device is not likely to be damaged due to failure to meet the high safety requirement. For example, in the first electrical connector provided in the embodiment of the present application, on a precondition that the spacing between the first contact part and the second contact part is smaller than 2 mm, the spacing between the first mating part and the second mating part is greater than or equal to 2 mm, and a creepage distance between the first mating part and the second mating part is also greater than or equal to 2 mm.

Furthermore, because the guide structure of the second electrical connector extends across the entire width direction of the second plastic body and has high strength, the guide structure is not easily damaged when the second electrical connector is inserted between the two side walls of the first electrical connector.

In the electrical connector combination provided in the embodiment of the present application combination, the second through hole 211 may be substantially “L”-shaped, so that the first end of one of the second through holes 211 is located on the end surface of the end of the second plastic body 21 from which the guide structure 23 protrudes, and one of the conductive terminals 22 protrudes out of the second through hole 211 from the second end of the second through hole 211.

As shown in FIG. 9, in the embodiment of the present application, the guide structure may include a plurality of protruding ribs (not shown in the figure) extending in the longitudinal direction of the second plastic body. Furthermore, the guide structure may further include at least one protruding rib (not shown in the figure) which is located at one end of the plurality of protruding ribs and extends in the width direction of the second plastic body.

In addition, in the embodiment of the present application, the guide structure may be a solid structure or have a grid-like cross section.

In this embodiment, the first electrical connector may be implemented in various manners described in the foregoing electrical connector embodiment.

As shown in FIG. 1 to FIG. 5, and FIG. 8 to FIG. 9, the present application further provides a circuit board combination, including a first circuit board 3, a second circuit board 4, a first electrical connector 1, and a second electrical connector 2.

The first electrical connector 1 includes a first plastic body 14, a first terminal 11, a second terminal 12, and side walls 15. The first terminal 11 includes a first connecting part 112, and a first contact part 111 and a first mating part 113 that extend from two ends of the first connecting part respectively. The first contact part 111 and the first mating part 113 are located at two sides of the first connecting part 112 respectively. An extending direction of the first contact part 111 deviates from a straight line of an extending direction of the first mating part 113. The second terminal 12 includes a second connecting part 122, and a second contact part 121 and a second mating part 123 that extend from two ends of the second connecting part 122 respectively. The first plastic body 14 is opened with a plurality of first through holes 141. The first terminal 11 and the second terminal 12 pass through the first through holes 141 of the first plastic body 14 respectively. The first contact part 111 and the first mating part 113 of the first terminal 11 respectively protrude out of the first through hole 141 that the first terminal 11 passes through. The second contact part 121 and the second mating part 123 of the second terminal 12 respectively protrude out of the first through hole 141 that the second terminal 12 passes through. A spacing between the first mating part 113 and the second mating part 123 is greater than a spacing between the first contact part 111 and the second contact part 121. The side walls 15 are located at two ends of the first plastic body 14, and extend in a direction substantially parallel to the first contact part 111 or the second contact part 121.

The second electrical connector 2 includes a second plastic body 21 which is in an elongated shape and is opened with second through holes 211, conductive terminals 22 disposed in the second through holes 211 of the second plastic body 21, and a guide structure 23 protruding from one end of the second plastic body 21 in a longitudinal direction. The guide structure 23 extends across an entire width direction of the second plastic body 21. A first end of one of the second through holes 211 is located on an end surface of the end of the second plastic body 21 from which the guide structure 23 protrudes. One of the conductive terminals 22 protrudes out of the second through hole 211 from a second end of the second through hole 211.

One end of the second electrical connector 2 from which the guide structure 23 protrudes is inserted between the two side walls 15 of the first electrical connector 1, and the first contact part 111 and the second contact part 121 of the first electrical connector 1 are inserted into the second through holes 211 from first ends of the second through holes 211, so as to be electrically connected to the conductive terminals 22 of the second electrical connector 2.

The first mating part 113 and the second mating part 123 of the first electrical connector 1 are inserted into or soldered to the first circuit board 3 respectively, so as to be electrically connected to the first circuit board 3. One end which is of the conductive terminals 22 of the second electrical connector 2 and protrudes out of the second through holes 211 is inserted into or soldered to the second circuit board 4, so as to be electrically connected to the second circuit board 4.

In the circuit board combination provided in the embodiment of the present application, because the first contact part and the second contact part are disposed at a small spacing and a high density, high density mating with the conductive terminals of the second electrical connector can be implemented, and because the first mating part and the second mating part are disposed at a large spacing and a low density, a large creepage distance is provided, which may meet a high safety requirement, so that a device is not likely to be damaged due to failure to meet the high safety requirement. For example, in the first electrical connector provided in the embodiment of the present application, on a precondition that the spacing between the first contact part and the second contact part is smaller than 2 mm, the spacing between the first mating part and the second mating part is greater than or equal to 2 mm, and a creepage distance between the first mating part and the second mating part is also greater than or equal to 2 mm.

When the first mating part and the second mating part are electrically connected to the first circuit board, the circuit board is provided with mounting holes or soldering pads, and the first mating part and the second mating part are inserted into the mounting holes or soldered to the soldering pads, so as to implement an electrical connection with the circuit board. Because the spacing between the first mating part and the second mating part is greater than or equal to 2 mm, a spacing between the mounting holes or the soldering pads on the circuit board is also greater than or equal to 2 mm, which may meet a high safety requirement, so that burnout of the circuit board is not likely to occur.

Furthermore, because the guide structure of the second electrical connector extends across the entire width direction of the second plastic body and has high strength, the guide structure is not easily damaged when the second electrical connector is inserted between the two side walls of the first electrical connector.

As shown in FIG. 9, in the embodiment of the present application, the guide structure may include a plurality of protruding ribs extending in the longitudinal direction of the second plastic body. Furthermore, the guide structure may further include at least one protruding rib which is located at one end of the plurality of protruding ribs and extends in the width direction of the second plastic body.

In addition, in the embodiment of the present application, the guide structure may be a solid structure or have a grid-like cross section.

In this embodiment, the first electrical connector may be implemented in various manners described in the foregoing electrical connector embodiment.

The foregoing description is merely several embodiments of the present application. A person skilled in the art may make various variations or modifications to the present application according to the disclosure of the application document without departing from the scope of the present application.

What is claimed is:

1. An electrical connector, comprising:
a plastic body;
a first terminal comprising a first connecting part, and a first contact part and a first mating part that extend from two ends of the first connecting part respectively, the first contact part and the first mating part are located at two sides of the first connecting part respectively, and an extending direction of the first contact part deviates from a straight line of an extending direction of the first mating part;
a second terminal comprising a second connecting part, and a second contact part and a second mating part that extend from two ends of the second connecting part respectively; and
wherein the plastic body is opened with a plurality of through holes, the first terminal and the second terminal pass through the through holes of the plastic body respectively, the first contact part and the first mating part of the first terminal respectively protrude out of the through hole that the first terminal passes through, and the second contact part and the second mating part of the second terminal respectively protrude out of the through hole that the second terminal passes through; and a spacing between the first mating part and the second mating part is greater than a spacing between the first contact part and the second contact part.

2. The electrical connector according to claim 1, wherein a straight line of the extending direction of the first contact part is substantially parallel to the straight line of the extending direction of the first mating part, and the first terminal is substantially “Z”-shaped.

3. The electrical connector according to claim 1, wherein the first mating part of the first terminal comprises: at least one pin and a holding part, the pin and the first connecting part are connected to two opposite ends of the holding part respectively, and the holding part is used for fixing the first terminal to the through hole of the plastic body.

4. The electrical connector according to claim 3, wherein the first mating part further comprises poles, each pole protrudes from an end surface of one end of the holding part, and the end surface is an end surface of the end connected to the first connecting part.

5. The electrical connector according to claim 1, wherein the second contact part and the second mating part are located at two sides of the second connecting part respectively, and an extending direction of the second contact part deviates from a straight line of an extending direction of the second mating part.

6. The electrical connector according to claim 5, wherein the first terminal is disposed opposite to the second terminal, so that the spacing between the first mating part and the second mating part is greater than the spacing between the first contact part and the second contact part.

7. The electrical connector according to claim 5, wherein a straight line of the extending direction of the second contact part is substantially parallel to the straight line of the extending direction of the second mating part.

8. The electrical connector according to claim 7, wherein the second terminal is substantially “Z”-shaped.

9. The electrical connector according to claim 1, wherein the straight line of the extending direction of the second contact part substantially coincides with the straight line of the extending direction of the second mating part.

10. The electrical connector according to claim 9, wherein the first terminal is disposed facing the second terminal, so that the spacing between the first mating part and the second mating part is greater than the spacing between the first contact part and the second contact part.

11. The electrical connector according to claim 9, wherein the second terminal is substantially “1”-shaped.

12. The electrical connector according to claim 1, wherein the plastic body is opened with a continuous or intermittent groove or provided with a continuous or intermittent protruding rib on a surface facing the first contact part and the second contact part, and the groove or the protruding rib is located between the first contact part and the second contact part.

13. An electrical connector combination, comprising a first electrical connector and a second electrical connector,
wherein the first electrical connector comprises:
a first plastic body being opened with a plurality of first through holes;
a first terminal comprising a first connecting part, and a first contact part and a first mating part that extend from two ends of the first connecting part respectively, the first contact part and the first mating part are located at two sides of the first connecting part respectively, and an extending direction of the first contact part deviates from a straight line of an extending direction of the first mating part;
a second terminal comprising a second connecting part, and a second contact part and a second mating part that extend from two ends of the second connecting part respectively; and
side walls located at two ends of the first plastic body;
wherein the first terminal and the second terminal pass through the first through holes of the first plastic body respectively, the first contact part and the first mating part of the first terminal respectively protrude out of the first through hole that the first terminal passes through, and the second contact part and the second mating part of the second terminal respectively protrude out of the first through hole that the second terminal passes through;
wherein a spacing between the first mating part and the second mating part is greater than a spacing between the first contact part and the second contact part; and extend in a direction substantially parallel to the first contact part or the second contact part;
the second electrical connector comprises a second plastic body which is in an elongated shape and is opened with second through holes, conductive terminals disposed in the second through holes of the second plastic body, and a guide structure protruding from one end of the second plastic body in a longitudinal direction, the guide structure extends across an entire width direction of the second plastic body, a first end of one of the second through holes is located on an end surface of the end of the second plastic body from which the guide structure protrudes, and one of the conductive terminals protrudes out of the second through hole from a second end of the second through hole; and
wherein one end of the second electrical connector from which the guide structure protrudes is inserted between the two side walls of the first electrical connector, and the first contact part and the second contact part of the first electrical connector are inserted into the second through holes from first ends of the second through holes, so as to be electrically connected to the conductive terminals of the second electrical connector.

14. The electrical connector combination according to claim 13, wherein the guide structure comprises a plurality of protruding ribs extending in the longitudinal direction of the second plastic body.

15. The electrical connector combination according to claim 14, wherein the guide structure further comprises at least one protruding rib which is located at one end of the plurality of protruding ribs and extends in the width direction of the second plastic body.

16. The electrical connector combination according to claim 13, wherein the guide structure is a solid structure or has a grid-like cross section.

17. The electrical connector combination according to claim 13, wherein a straight line of the extending direction of the first contact part is substantially parallel to the straight line of the extending direction of the first mating part.

18. The electrical connector combination according to claim 16, wherein the first terminal is substantially “Z”-shaped.

19. The electrical connector combination according to claim 13, wherein the first mating part of the first terminal comprises: at least one pin and a holding part, the pin and the first connecting part are connected to two opposite ends of the holding part respectively, and the holding part is used for fixing the first terminal to the first through hole of the first plastic body.

20. A circuit board combination, comprising a first circuit board, a second circuit board, and the electrical connector combination according to claim 15, wherein:
the first mating part and the second mating part of the first electrical connector in the electrical connector combination are inserted into or soldered to the first circuit board respectively, so as to be electrically connected to the first circuit board; and one end which is of the conductive terminals of the second electrical connector in the electrical connector combination and protrudes out of the second through holes is inserted into or soldered to the second circuit board, so as to be electrically connected to the second circuit board.
